(19) United States
(12) Patent Application Publication
(10) Pub. No.: US 2026/0027503 A1
(43) Pub. Date: Jan. 29, 2026

(54) MULTI-STAGE PARTICULATE FILTER INCLUDING A CLEANING MECHANISM

(71) Applicant: Pentair, Inc., Golden Valley, MN (US)

(72) Inventors: Sunil Verma, Faridabad (IN); Abhilash Shishodia, Gautam Buddha Nagar (IN); Anupam Dubey, Gaur City 1 (IN); Stephen Kyle Jenkins, Houston, TX (US)

(21) Appl. No.: 19/278,152

(22) Filed: Jul. 23, 2025

Related U.S. Application Data
(60) Provisional application No. 63/675,062, filed on Jul. 24, 2024.

(51) Int. Cl. B01D 46/52; B01D 46/00

(52) U.S. Cl. CPC B01D 46/521; B01D 46/0005; B01D 46/0034; B01D 2201/12

(57) ABSTRACT

An apparatus is provided in the form of a housing and a multi-stage particulate filter positioned within, and in fluid communication with, the housing. The multi-stage particulate filter, designed to create a filtered fluid from an untreated fluid, is provided in the form of an enclosure with a first end and a second end, a magnetic rod, and a pleated filter. The magnetic rod is configured to attract and remove magnetic particles from the untreated fluid passing through the multi-stage particulate filter. The pleated filter is designed to selectively couple to the enclosure when positioned within the enclosure. The pleated filter includes a closed end cap couplable to the first end of the enclosure, and an aperture within the closed end cap receives the magnetic rod. Removal of the pleated filter from the enclosure removes the magnetic particles deposited on the magnetic rod, thereby cleaning the magnetic rod.

### CROSS-REFERENCE TO RELATED APPLICATIONS

This application claims priority to U.S. Provisional Patent Application Ser. No. 63/675,062, filed on Jul. 24, 2024, entitled “MULTI-STAGE PARTICULATE FILTER WITH CLEANING MECHANISM,” currently pending, the entire disclosure of which is incorporated herein by reference.

### TECHNICAL FIELD

The present disclosure relates to a multi-stage particulate filter. More particularly, the present disclosure relates to a multi-stage particulate filter with an integrated cleaning mechanism.

### BACKGROUND

Particulate filters are used for filtering fluids (e.g., water, oil, chemicals, aqueous solutions, and beverages) by removing unwanted particles (e.g., solids) from the fluid. In some instances, unwanted particles imparted with ferromagnetic properties dispersed in the fluid can become trapped within the particulate filter. Due to this contamination, the particulate filter's efficiency can be reduced, leading to a decreased life span of the filter. Additionally, when the unwanted particles with ferromagnetic properties clog or foul the particulate filter, frequent changes or replacement of the particulate filter may be required.

Current solutions rely on replacing the particulate filter, which can be costly as well as time consuming for the end user. Thus, there is a demonstrated need for solutions that prevent ferromagnetic particles from becoming trapped in the particulate filter and allow for the ferromagnetic contaminants to be easily removed from the particulate filter.

### SUMMARY

A pressure vessel is provided. The pressure vessel includes a housing and a multi-stage particulate filter positioned within the housing. The multi-stage particulate filter includes a perforated cage and a pleated filter positioned within the perforated cage. The perforated cage has a first end and a second end. The pleated filter includes a central hollow cavity and a closed end cap connected to the first end of the perforated cage. Further, the central hollow cavity and an aperture of the closed end cap can accommodate a magnetic rod, which is connected to the perforated cage. The magnetic rod is designed to attract and deposit particles from the fluid passing through the central hollow cavity of the perforated cage. Also, the pleated filter, along with the closed end cap, can be pulled out of the perforated cage from the first end to the second end of the perforated cage. Furthermore, the removal of the pleated filter along with the closed end cap from the perforated cage removes deposited particles on the magnetic rod, thereby cleaning the magnetic rod.

In some aspects, an apparatus is provided in the form of a housing and a multi-stage particulate filter. The multi-stage particulate filter is positioned within the housing. The multi-stage particulate filter, designed to create a filtered fluid from an untreated fluid, is provided in the form of an enclosure, a magnetic rod, and a pleated filter. The enclosure includes a first end and a second end. The magnetic rod is configured to remove magnetic particles from the untreated fluid passing through the multi-stage particulate filter. The pleated filter is designed to selectively couple to the enclosure when the pleated filter is positioned within the enclosure. The pleated filter includes a closed end cap couplable to the first end of the enclosure.

In some instances, the housing is provided in the form of a pressure vessel, a fluid inlet, and a fluid outlet. The fluid inlet is in fluid communication with a source of the untreated fluid, and the fluid outlet provides the filtered fluid from the pressure vessel.

In some such instances, the housing further includes a tube sheet designed to receive the fluid from the fluid inlet and pass the fluid to the multi-stage particulate filter.

In other instances, the magnetic rod attracts magnetic particles from the untreated fluid to create a prefiltered fluid in a first filtration stage. In further instances, the pleated filter filters the prefiltered fluid to create the filtered fluid during a second filtration stage.

In other such instances, the untreated fluid is imparted with a first contaminant concentration, the prefiltered fluid is imparted with a second contaminant concentration, and the filtered fluid is imparted with a third contaminant concentration. The first contaminant concentration is greater than both the second contaminant concentration and the third contaminant concentration.

In yet other instances, the closed end cap includes a body with an opening extending through the body, and the opening is configured to receive the magnetic rod. In further instances, the opening includes a contacting surface designed to remove the magnetic particles deposited on the magnetic rod when the magnetic rod is moved through the opening.

In other instances, the magnetic rod comprises a first rod end and a second rod end, where the first rod end comprises a fastening mechanism. In some such instances, the first rod end of the magnetic rod is coupled to the first end of the enclosure by the fastening mechanism, and the closed end cap of the pleated filter is sized and shaped to receive the magnetic rod.

In other instances, the pleated filter includes a hollow cavity that is in fluid communication with the second end of the enclosure.

In some instances, the pleated filter is positioned within the enclosure when the pleated filter is coupled to the enclosure.

In other instances, an aperture of the closed end cap is designed to receive the magnetic rod. In some such instances, the removal of the pleated filter from the enclosure removes the magnetic particles deposited on the magnetic rod, thereby cleaning the magnetic rod.

In yet other instances, when the pleated filter is removed from the enclosure, the magnetic rod remains coupled to the enclosure.

In other aspects, a filter is provided in the form of a perforated enclosure, a pleated filter, and a magnetic rod. The perforated enclosure includes a first end and a second end. The pleated filter includes a body and a closed end cap including an opening. The body defines a central cavity, and the closed end cap is couplable to the first end of the perforated enclosure and includes an aperture. The magnetic rod is positioned within the perforated enclosure such that the magnetic rod is couplable to the opening of the closed end cap and abuts the opening when coupled thereto. The magnetic rod attracts particles from a fluid passing through the central hollow cavity of the pleated filter. The pleated filter is selectively couplable to the perforated enclosure such that the pleated filter is selectively removable from the perforated enclosure. The opening of the closed end cap is disposed around the magnetic rod such that a surface of the closed end cap removes particles deposited on the magnetic rod when the pleated filter is removed from the perforated enclosure.

In some cases, the surface of the closed end cap defines the opening.

In certain instances, the opening is sized and shaped to receive the magnetic rod. In some such instances, a first diameter of the opening and a second diameter of the magnetic rod are substantially equal.

In some cases, the opening of the closed end cap extends through a protrusion of the closed end cap. The protrusion extends upwardly and away from a base of a body of the closed end cap.

In other instances, the surface of the closed end cap is configured to contact a body of the magnetic rod when the magnetic rod is coupled to the closed end cap, and the surface of the closed end cap is configured to maintain contact with the body of the magnetic rod as the pleated filter is removed from the perforated enclosure.

In yet other instances, the pleated filter is configured to be decoupled from or removed from the perforated enclosure by pulling the pleated filter away from the first end of the perforated enclosure.

In some instances, the magnetic rod is received within the central hollow cavity and the closed end cap of the pleated filter when the pleated filter is coupled to the perforated enclosure.

In other instances, the magnetic rod is coupled to the perforated enclosure such that the magnetic rod remains in the perforated enclosure as the pleated filter is removed from the perforated enclosure.

In yet other instances, the magnetic rod is coupled to the closed end cap of the perforated enclosure via at least one fastening mechanism.

In some instances, the perforated enclosure is provided in the form of a mesh structure configured to allow fluid to flow through the perforated enclosure.

In yet other aspects, a method of filtering a fluid is provided. The method includes the steps of providing an untreated fluid and providing a filtration apparatus. The filtration apparatus is provided in the form of an enclosure, a magnetic rod, and a pleated filter. The magnetic rod is coupled to the enclosure. The pleated filter substantially surrounds the magnetic rod when inserted into the filtration apparatus. The method further includes the step of removing magnetic particles from the untreated fluid with the magnetic rod, thereby generating a prefiltered fluid. The method also includes the step of filtering the prefiltered fluid with the pleated filter, thereby generating a filtered fluid.

In some instances, the method further includes a step of cleaning the magnetic rod by removal of the pleated filter from the filtration apparatus.

In other instances, the untreated fluid is imparted with a first contaminant concentration, the prefiltered fluid is imparted with a second contaminant concentration that is substantially equal to or less than the first contaminant concentration, and the filtered fluid is imparted with a third contaminant concentration that is substantially equal to or less than the second contaminant concentration.

### DESCRIPTION OF THE DRAWINGS

FIG. 1A is an isometric view of a pressure vessel including a multi-stage particulate filter constructed according to the teachings herein, a portion of an outer surface of the multi-stage particulate filter rendered transparent for the purposes of clarity, and other features of the multi-stage particulate filter omitted for the purposes of clarity;

FIG. 1B is a cross-sectional view of the pressure vessel of FIG. 1A, the cross-sectional view taken along the line 1B-1B of FIG. 1A;

FIG. 2A is an isometric view of a multi-stage particulate filter designed for use with the pressure vessel of FIGS. 1A and 1B, a perforated enclosure of the multi-stage particulate filter rendered transparent and without perforations for the purposes of clarity, and a pleated filter of the multi-stage particulate filter rendered semi-transparent for the purposes of clarity;

FIG. 2B is a representational cross-sectional view of the multi-stage particulate filter of FIG. 2A, the multi-stage particulate filter shown in an assembled configuration;

FIG. 2C is a representational, partially exploded cross-sectional view of the multi-stage particulate filter of FIG. 2A;

FIG. 3A is an isometric side view of the perforated enclosure of the multi-stage particulate filter of FIGS. 2A-2C;

FIG. 3B is a right-side view of the perforated enclosure of the multi-stage particulate filter of FIGS. 2A-2C;

FIG. 4A is an isometric side view of the pleated filter of the multi-stage particulate filter of FIGS. 2A-2C, with pleats positioned at a first end of the pleated filter rendered semi-transparent so that selected internal components of the pleated filter are visible;

FIG. 4B is an isometric view of the pleated filter of the multi-stage particulate filter of FIGS. 2A-2C shown in an upright configuration;

FIG. 4C is an isometric view of the pleated filter of the multi-stage particulate filter of FIGS. 2A-2C shown in another upright configuration;

FIG. 5 is an isometric top view of a closed end cap of the multi-stage particulate filter of FIGS. 2A-2C;

FIG. 6 is an isometric bottom view of the closed end cap of FIG. 5;

FIG. 7 is an isometric view of a magnetic rod of the multi-stage particulate filter of FIGS. 2A-2C;

FIG. 8A is a representational cross-sectional view of the multi-stage particulate filter of FIGS. 2A-2C in a first configuration;

FIG. 8B is a representational cross-sectional view of the multi-stage particulate filter of FIGS. 2A-2C in a second configuration; and

FIG. 8C is a representational cross-sectional view of the multi-stage particulate filter of FIGS. 2A-2C in a third configuration.

### DETAILED DESCRIPTION

Before any instances of the disclosure are explained in detail, it is to be understood that the disclosure is not limited in its application to the details of construction and the arrangement of components set forth in the following description or illustrated in the following drawings. The disclosure is capable of other instances and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

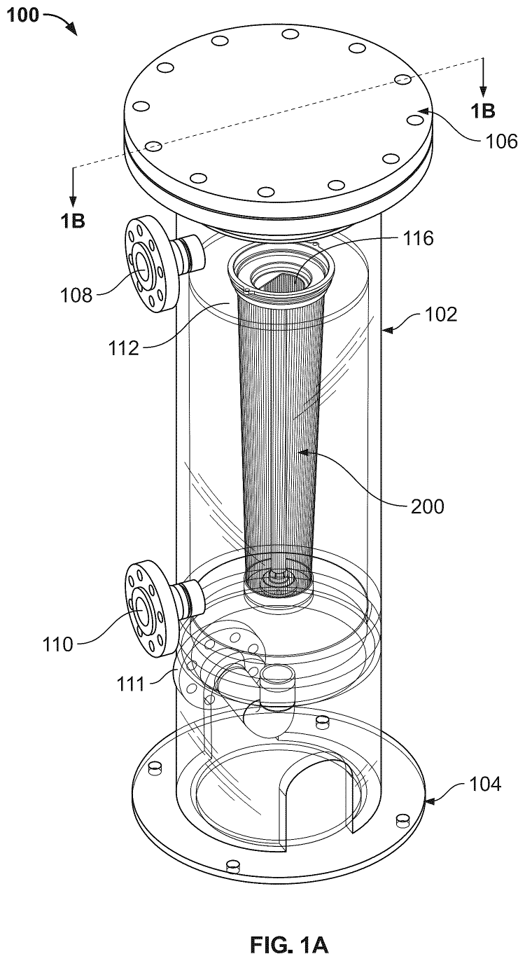

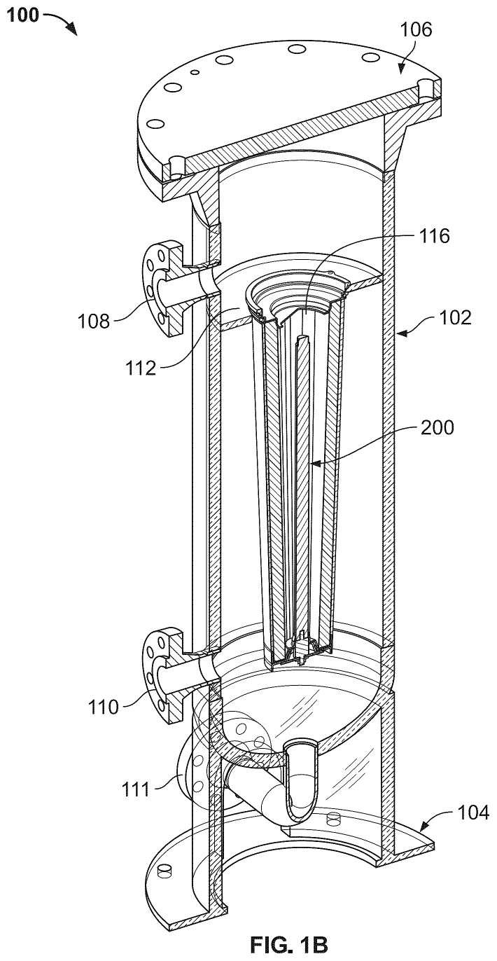

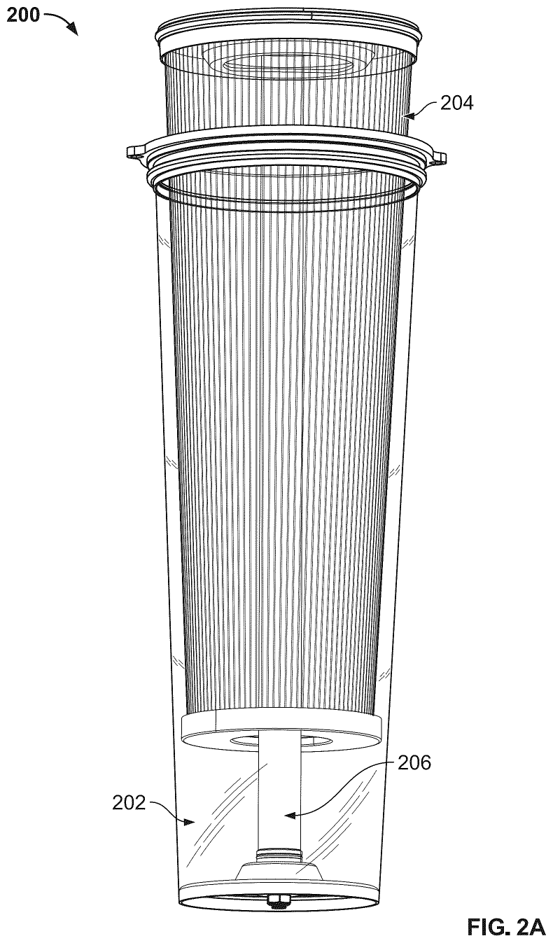

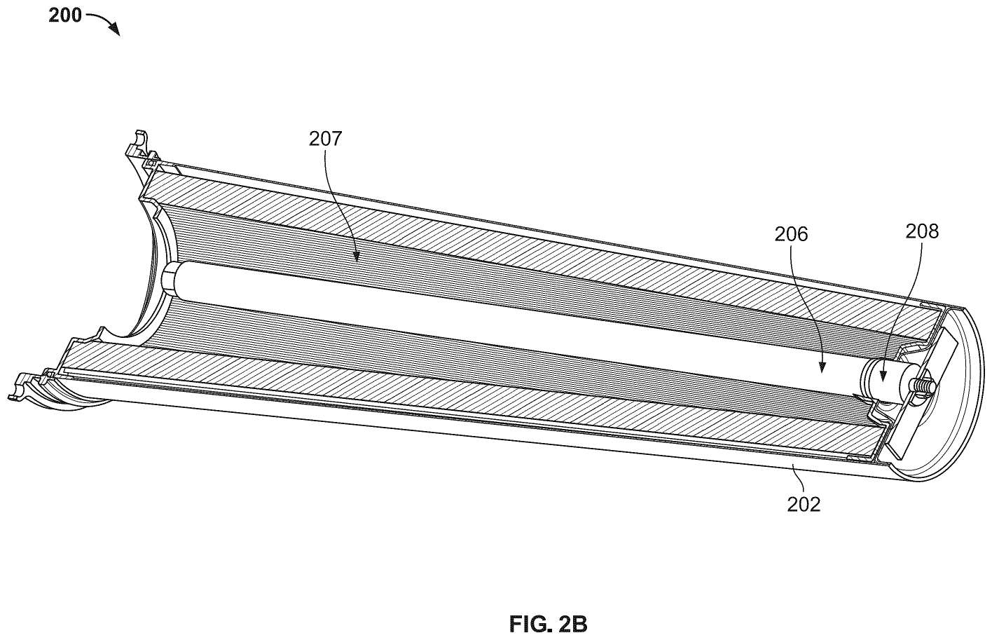

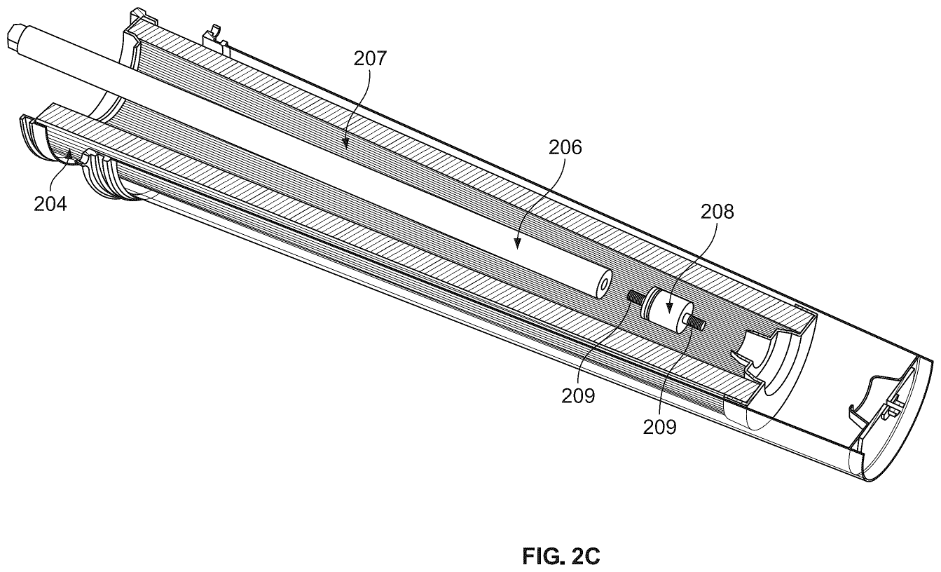

With respect to respective components of a pressure vessel, when the pressure vessel is viewed in a vertical position (as shown in FIGS. 1A and 1B), the terms “top,” “bottom,” “left,” “right,” “below,” “above,” “adjacent,” “beneath,” “inside,” “within,” “longitudinally,” and the like describe the components' disposition along the vertical direction relative to each other and are used for the sake of convenience. Thus, for example, referring to FIG. 1A, a first side of a pressure vessel is disposed “below” a second side of the pressure vessel. Or, as an additional example, the second side of the pressure vessel is disposed on the “top” of the pressure vessel, respective to vertical orientation of FIG. 1A. “Longitudinally” with respect to a component of the pressure vessel, referring to FIG. 1A again, refers to a component arranged along the y-axis of the pressure vessel, or put simply, arranged vertically. “Within” with respect to two components of a pressure vessel means further that the one component is disposed within a cavity or a structure of the second component. For example, referring to FIG. 2B, a ferromagnetic rod is disposed “inside” of a particulate filter, meaning the ferromagnetic rod is disposed within an internal cavity, a structure, or an open space of the particulate filter.

The following discussion is presented to enable a person skilled in the art to make and use instances of the disclosure. Various modifications to the illustrated instances will be readily apparent to those skilled in the art, and the generic principles herein can be applied to other instances and applications without departing from instances of the disclosure. Thus, instances of the disclosure are not intended to be limited to instances shown but are to be accorded the widest scope consistent with the principles and features disclosed herein. The following detailed description is to be read with reference to the figures, in which like elements in different figures have like reference numerals. The figures, which are not necessarily to scale, depict selected instances and are not intended to limit the scope of instances of the disclosure. Skilled artisans will recognize the examples provided herein have many useful alternatives and fall within the scope of instances of the disclosure.

Additionally, while the following discussion may describe features associated with specific devices or instances, it is understood that additional devices and/or features can be used with the described systems and methods, and that the discussed devices and features are used to provide examples of possible instances, without being limiting.

According to the teachings herein, a multi-stage particulate filter including an integrated cleaning mechanism is provided. The multi-stage particulate filter may be provided within a housing of a pressure vessel and/or within the housing of any apparatus designed to receive a fluid. In various instances, the multi-stage particulate filter may include a perforated enclosure and a pleated filter selectively couplable to the perforated enclosure. The perforated enclosure may have a first end and a second end. In some instances, the pleated filter may have a central hollow cavity and include a closed end cap selectively couplable to the first end of the perforated enclosure.

In multiple instances, the central hollow cavity of the pleated filter may accommodate a magnetic rod that is coupled to the perforated enclosure. The magnetic rod may be configured to attract and retain particles from the fluid passing through the central hollow cavity of the pleated filter. In additional instances, the pleated filter and the closed end cap may be pulled outside of or removed from the perforated enclosure. As the pleated filter is removed from the perforated enclosure, the closed end cap may remove particles deposited on the magnetic rod, thereby cleaning the magnetic rod.

The multi-stage particulate filter described herein may reduce the concentration of contaminants or particulates dispersed in the fluid provided to the multi-stage particulate filter. For example, the fluid provided to the multi-stage particulate filter may be imparted with a first contaminant concentration and, after filtration by the filter, the fluid may be imparted with a second contaminant concentration that is less than the first contaminant concentration.

The multi-stage particulate filter may remove contaminants from the fluid in one or more stages. For example, the multi-stage particulate filter may, in a first stage, remove magnetic particles (e.g., ferromagnetic particles) from the fluid via the action of the magnetic rod, thereby imparting the fluid with a second contaminant concentration that is substantially equal to or less than the first contaminant concentration. Then, in a second stage, the multi-stage particulate filter may remove contaminants not captured by the magnetic rod from the fluid (including, in some instances, any ferromagnetic particles that are not captured by the magnetic rod), thereby imparting the fluid with a third contaminant concentration that is substantially equal to or less than the second contaminant concentration.

Referring now to FIGS. 1A and 1B together, a pressure vessel 100 is provided in the form of a housing 102 with a first side 104 and a second side 106, a fluid inlet 108, a first fluid outlet 110, a second fluid outlet 111, a tube sheet 112, and a multi-stage particulate filter 200. As used herein, the term “pressure vessel 100” may refer to any vessel that is provided as a closed container adapted for, among other things, refining oil and gas products, processing petrochemicals, feedstock processing, pumping and/or compressing fluids, and/or processing liquids, vapors, and/or gases at a pressure somewhat or significantly higher or lower than ambient pressure. In some instances, the pressure vessel 100 may not be provided. In such instances, the multi-stage particulate filter 200 may instead be provided in a different housing or structure, or the multi-stage particulate filter 200 may not be provided in a housing.

In some instances, the housing 102 may be substantially cylindrical, although the pressure vessel may also be provided in other shapes and forms. In some instances, the first side 104 is located on a bottom side of the pressure vessel 100. In some instances, the second side 106 is located on a top side of the pressure vessel 100. In other instances, the first side 104 and the second side 106 may be disposed in opposite positions, or the first side 104 may be located on the top side of the pressure vessel 100 and the second side 106 may be located on the bottom side of the pressure vessel.

In various instances, the pressure vessel 100 comprises a fluid inlet 108 configured to allow one or more fluids to enter the housing 102. The one or more fluids may be provided to the fluid inlet 108 from any fluid source including, but not limited to, pipelines, deep wells, water-production systems, amine systems, boilers, turbines, lubricating oil systems, hydrotreating systems, and/or swimming pools or spas. In some instances, the one or more fluids may include water, beverages, chemical solutions, oil, hydrocarbons, produced water, fuel, gases, glycols, amines, sour water, diesel, wastewater, or any combination thereof.

In some instances, the fluid may flow onto a tube sheet 112 from the fluid inlet 108. The tube sheet 112 may be designed to direct the flow of fluid within the pressure vessel 100. The tube sheet 112 may include an opening 116 that is substantially cylindrical or circular. In addition, the opening 116 may be positioned at or near the center of the tube sheet 112. In some instances, the tube sheet 112 may be imparted with a different geometry, according to the geometry of the pressure vessel 100. For example, in an instance where the pressure vessel 100 may be rectangular, the tube sheet 112 may be rectangular in accordance with a horizontal cross-sectional geometry of the pressure vessel 100. Further, the opening 116 of the tube sheet 112 may also be an alternative geometry, including any polygonal shape or any irregular shape. In addition, the tube sheet 112 may act as a receptacle for the multi-stage particulate filter 200 when the multi-stage particulate filter 200 is positioned inside the housing 102 (e.g., the multi-stage particulate filter 200 may couple to the tube sheet 112). In such instances, the tube sheet 112 may help retain the multi-stage particulate filter 200 in a desired position in the housing 102.

In various instances, the fluid may pass through the opening 116 of the tube sheet 112 and then enter into and/or pass through the multi-stage particulate filter 200. The multi-stage particulate filter 200 is designed to remove ferromagnetic particles (i.e., particles that react to a magnetic field) from the fluid or a ferrofluid, along with other contaminants. In some instances, the ferromagnetic particles removed from the fluid by the multi-stage particulate filter 200 may also include ferrimagnetic particles. A ferrofluid may be any fluid including a dispersion of ferromagnetic particles. In some cases, the multi-stage particulate filter 200 may remove some, most, substantially all, or all of the ferromagnetic particles from a fluid provided to the multi-stage particulate filter 200. In various instances, the multi-stage particulate filter 200 may remove some, most, substantially all, or all of the ferrimagnetic particles from a fluid provided to the multi-stage particulate filter 200.

In some instances, the pressure vessel 100 may include any number of multi-stage particulate filters 200 arranged in any manner or position within the pressure vessel 100. For example, the pressure vessel 100 may include at least one multi-stage particulate filter 200 arranged longitudinally within the pressure vessel 100. As an additional example, the pressure vessel 100 may include at least three multi-stage particulate filters 200 arranged vertically in a serial configuration. As yet another example, the pressure vessel 100 may include two multi-stage particulate filters 200 arranged in a parallel configuration. It is to be understood the multi-stage particulate filter(s) 200 may be arranged in any orientation within the pressure vessel 100 or another housing.

In some instances, after the multi-stage particulate filter 200 filters or processes the fluid, the processed fluid may exit the housing 102 of the pressure vessel 100 via the first fluid outlet 110. In other cases, the processed fluid may exit the housing 102 of the pressure vessel 100 via the second fluid outlet 111. In some cases, the first fluid outlet 110 may be coupled to a fluid line that is designed to carry the processed fluid such that the processed fluid may be collected, stored, and/or further processed. In some instances, the second fluid outlet 111 may be coupled to a fluid line that is in fluid communication with a drain. In such instances, after the pressure vessel 100 has been provided with a washing fluid, the washing fluid may be sent to the drain via the second fluid outlet 111.

In additional instances, the fluid inlet 108 may be positioned at or near to the second side 106 of the housing 102 of the pressure vessel 100 and the first fluid outlet 110 may be positioned at or near to the first side 104 of the housing 102 of the pressure vessel 100. The disposition of the fluid inlet 108 and the first fluid outlet 110 may be arranged according to a particular use of a particular pressure vessel 100; as such the position and arrangement of the fluid inlet 108 and the first fluid outlet 110 are not particularly limited. For example, in some instances, it may be preferable to have a pressure vessel including a fluid inlet 108 at or near the first side 104 of the housing 102 instead of the second side 106 of the housing 102.

Referring to FIGS. 2A-2C, the multi-stage particulate filter 200 may be provided in the form of a perforated cage or perforated enclosure 202, a pleated filter 204 selectively positionable within the perforated enclosure 202, and a magnetic rod 206 positioned within the perforated enclosure 202 and the pleated filter 204. The magnetic rod 206 may extend through an internal cavity 207 of the pleated filter 204 when the pleated filter 204 is inserted in the multi-stage particulate filter 200. For the sake of clarity, the perforations or “holes” provided in the perforated enclosure 202 are not illustrated in FIGS. 1A, 1B, 2A, 2B, and 8A-8C.

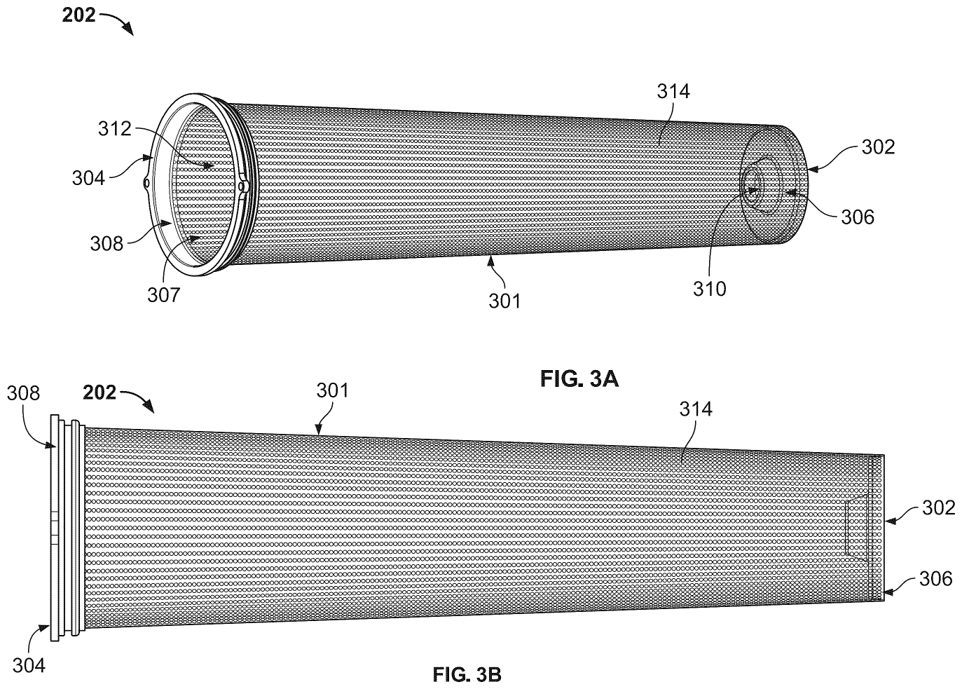

Generally, the perforated enclosure 202 may be provided as a substantially hollow, tapered cylinder with at least one open end, although the perforated enclosure may also be provided in other shapes and forms. In certain instances, the perforated enclosure 202 may have a uniform cross-section throughout a body of the perforated enclosure 202 such that the perforated enclosure does not taper on one end, although the perforated enclosure 202 may also be imparted with a tapered body. The perforated enclosure may also include pores or apertures extending entirely or substantially through the body of the perforated enclosure 202 (see, e.g., pores 314 of FIGS. 3A and 3B). However, the perforated enclosure 202 may also be provided in the form of any shape and may or may not include the pores 314. For example, in various instances, the perforated enclosure 202 may be provided as a rectangular prism that does not include apertures extending through the surfaces of the perforated enclosure 202. The perforated enclosure 202 may be composed of any type of metal including, but not limited to, steel, iron, and/or aluminum. Alternatively, the perforated enclosure 202 may be composed of any type of plastic or polymer, including, but not limited to, fiber-reinforced plastic (“FRP”).

In some instances, the pleated filter 204 may be provided in the form of a filter designed to remove particulates or contaminants from a fluid. For example, the pleated filter 204 may be provided as a string wound filter, a formed filter, an adsorption media filter, a carbon/resin media filter, a depth filter media, and/or a hollow fiber filter.

In various instances, the magnetic rod 206 may be provided in the form of an electromagnetic rod. In other instances, the magnetic rod 206 may be provided in the form of a plurality of magnets positioned inside or on a substantially cylindrical frame and/or supported by a substantially cylindrical frame. In various instances, the substantially cylindrical frame may be composed of stainless steel or any type of plastic. The magnetic rod 206 may also be provided in other shapes and forms besides those described herein.

In certain instances, the pleated filter 204 and the magnetic rod 206 may be designed to reduce the concentration of contaminants or particulates disposed within a fluid passing through the multi-stage particulate filter 200. For example, prior to the fluid entering the multi-stage particulate filter, the fluid may be imparted with a first concentration of contaminants. When the fluid enters the multi-stage particulate filter 200, the fluid may first flow into the internal cavity 207 of the pleated filter 204 where the magnetic rod 206 is disposed. Once the fluid is near the magnetic rod 206, ferromagnetic contaminants within the fluid may be drawn out of the fluid by the magnetic rod 206, thereby imparting the fluid with a second concentration of contaminants. As the fluid continues to flow through the internal cavity 207, the fluid may then pass through the pleated filter 204 itself. The pleated filter 204 may capture additional contaminants in the fluid, thereby imparting the fluid with a third concentration of contaminants. In some instances, the pleated filter 204 may be designed to remove non-magnetized and ferromagnetic particles and contaminants alike. More particularly, the pleated filter 204 may capture any ferromagnetic particles remaining in the fluid along with the non-magnetized contaminants.

The magnetic rod 206 may be imparted with different ferromagnetic strengths in various instances. For example, the magnetic rod 206 may be imparted with a ferromagnetic strength such that the magnetic rod 206 may remove some, most, substantially all, or all of the ferromagnetic contaminants within a fluid being processed by the multi-stage particulate filter 200. In some instances, the magnetic rod 206 may remove at least about 10%, or at least about 20%, or at least about 30%, or at least about 40%, or at least about 50%, or at least about 60%, or at least about 70%, or at least about 80%, or at least about 90%, or about 100% of the ferromagnetic contaminants from the fluid being processed by the multi-stage particulate filter 200. In other instances, the magnetic rod 206 may remove at least 10%, or at least 20%, or at least 30%, or at least 40%, or at least 50%, or at least 60%, or at least 70%, or at least 80%, or at least 90%, or 100% of the ferromagnetic contaminants from the fluid being processed by the multi-stage particulate filter 200.

Similarly, the pleated filter 204 may be designed to remove some, most, substantially all, or all of the remaining contaminants and/or particulates in the fluid being processed by the multi-stage particulate filter 200 after the fluid has passed by the magnetic rod 206. In some instances, the pleated filter 204 may remove at least about 10%, at least about 20%, at least about 30%, at least about 40%, at least about 50%, at least about 60%, at least about 70%, at least about 80%, at least about 90%, or about 100% of the contaminants and/or particulates from the fluid being processed. In other instances, the pleated filter 204 may remove at least 10%, at least 20%, at least 30%, at least 40%, at least 50%, at least 60%, at least 70%, at least 80%, at least 90%, or 100% of the contaminants and/or particulates from the fluid being processed.

In various instances, the second concentration of contaminants of the fluid may be less than the first concentration of contaminants, and the third concentration of contaminants may be less than the second concentration of contaminants. However, in instances in which there are no or substantially no ferromagnetic particles in the fluid provided to the multi-stage particulate filter 200, the first and second concentrations of contaminants may be substantially equal. In addition, in instances in which only ferromagnetic contaminants are present in the fluid provided to the multi-stage particulate filter 200, the second concentration of contaminants may be substantially equal to the third concentration of contaminants.

Referring to FIG. 2B, the magnetic rod 206 may be designed to be disposed within an internal cavity 207 of the pleated filter 204. In some instances, the magnetic rod 206 may extend laterally through the entirety of the internal cavity 207 of the pleated filter 204. In other instances, the magnetic rod 206 may only extend partially or substantially through the internal cavity 207 of the pleated filter 204.

As shown in FIG. 2C, the pleated filter and the magnetic rod 206 may be designed to be removably affixed to the multi-stage particulate filter 200. In such instances, the multi-stage particulate filter may further include a fastener 208. The fastener 208 may be designed to join to both the pleated filter 204 and the magnetic rod 206. In some instances, the fastener 208 may couple to the pleated filter 204 and the magnetic rod 206 (see, e.g., FIG. 2B). In such instances, as shown in FIG. 2C, the fastener 208 may be provided in the form of at least two fastenings 209, where the fastenings 209 may couple to the pleated filter 204 and the magnetic rod 206, respectively. In some instances, the fastenings 209 may be provided in the form of two bolts, where the bolts may couple to the pleated filter 204 and the magnetic rod 206. In other instances, the fastenings 209 may be provided in the form of other fixation mechanisms. For example, a snap fit, a screw, or other mechanical fasteners may be included. The pleated filter 204 may similarly include a mechanical fastening means to secure the pleated filter 204 within the perforated enclosure or the pleated filter 204 may be secured within the perforated enclosure 202 by the geometries of both components (i.e. the pleated filter 204 may be imparted with a cross-section that is only slightly smaller than that of the perforated enclosure 202.)

Together, FIGS. 3A-7 illustrate the various components of the perforated enclosure 202, the pleated filter 204, and the magnetic rod 206.

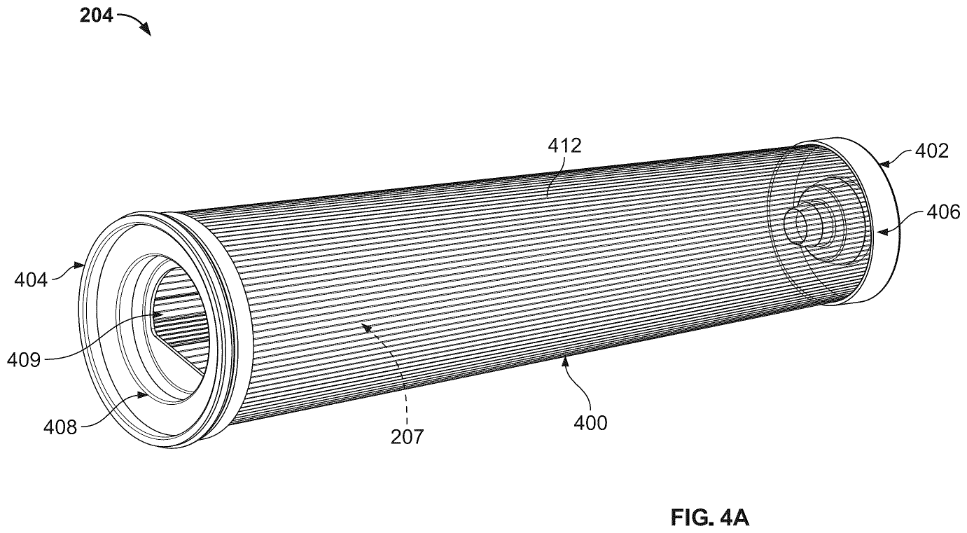

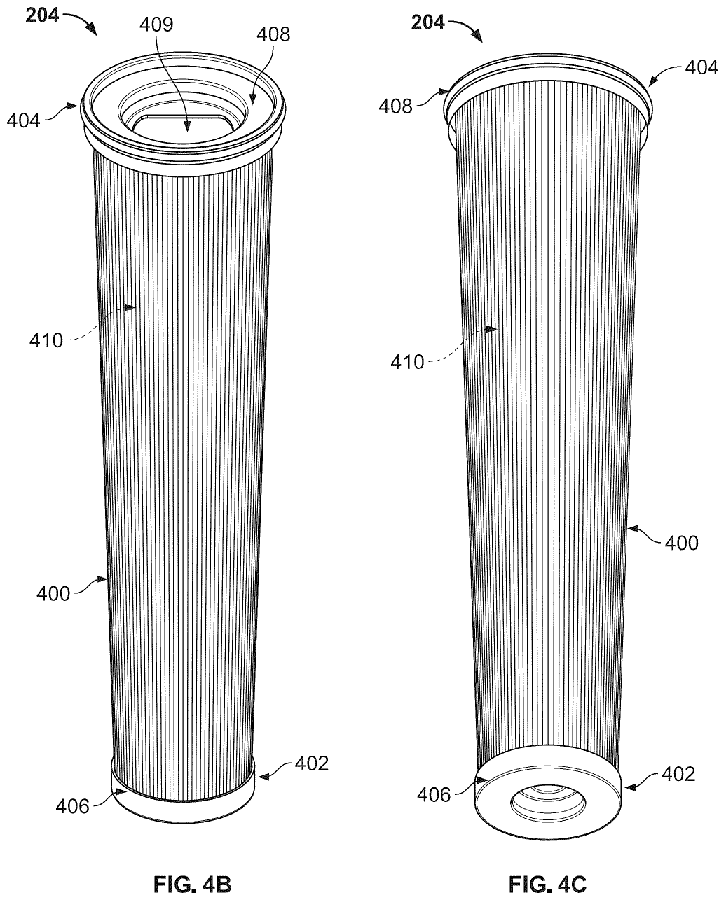

Turning first to FIGS. 3A and 3B, the perforated enclosure 202 of the multi-stage particulate filter 200 is provided in the form of a body 301 having a first end 302 and a second end 304, a closed end cap 306, an interior 307, an open end cap 308, a first aperture 310 positioned in and extending through the closed end cap 306, and a second aperture 312 positioned in and extending through the open end cap 308. In some instances, the perforated enclosure 202 does not include the end caps 306, 308, and ends caps are instead provided as part of the pleated filter 204. In certain instances, the end caps 306, 308 may couple to end caps provided with the pleated filter 204 (see, e.g., end caps 406, 408 of the pleated filter 204 of FIGS. 4A-4C).

The first end 302 of the perforated enclosure 202 may be located at a bottom side of the perforated enclosure 202 while the second end 304 may be located at a top side of the perforated enclosure 202. As used here, “top side” and “bottom side” are used to refer to the orientation of each end relative to the other when the perforated enclosure 202 is arranged vertically, and it is to be understood that the components of the perforated enclosure 202 may otherwise be arranged. In some instances, the closed end cap 306 may be coupled to the first end 302 of the perforated enclosure 202, and the open end cap 308 may be coupled to the second end 304. In various instances, the first aperture 310 may be positioned at or near a center of the closed end cap 306 and provided in a substantially circular shape, although the first aperture 310 may also be provided in other shapes. In some instances, the closed end cap 306 may be configured to close the first end 302 of the perforated enclosure 202 and the first aperture 310 may not be provided. While the perforated enclosure 202 is depicted in FIGS. 3A and 3B as substantially cylindrical, other geometries may be suitable, including, but not limited to, rectangular prisms, hexagonal prisms, octagonal prisms, or other polygonal prisms. In instances where the perforated enclosure 202 is imparted with one of these geometries, the other components of the perforated enclosure 202 may similarly be imparted with a different geometry corresponding to the overall geometry of the perforated enclosure 202.

In various instances, the body 301 of the perforated enclosure 202 is coupled to or integrally formed with the closed end cap 306 and the open end cap 308. In certain instances, the closed end cap 306 and the open end cap 308 may be designed to be detached from and recoupled to the body 301. The body 301 may be coupled to the closed end cap 306 and the open end cap 308 by mechanical means or adhesive means. In other instances, the end caps 306, 308 may be integrally formed with the perforated enclosure 202 such that the end caps 306, 308 may not be detached from the body 301.

The body 301 may be configured as a mesh structure including small open pores or apertures (i.e., the pores 314) extending through the body 301. The pores 314 may be provided throughout a length of the body 301 such that substantially all of the body 301 includes the pores 314. The pores 314 may be designed to allow for the flow of fluid into and out of the perforated enclosure 202. In some instances, the pores 314 may also be designed to prevent particles with a diameter slightly or somewhat larger than a diameter of the pores 314 from entering and/or exiting the perforated enclosure 202. In other instances, the body 301 may include other pore types that are imparted with different geometries and sizes than those depicted in FIGS. 3A and 3B. In addition, the body 301 may include more than one pore type (e.g., a first set of pores provided in a first size and shape and a second set of pores provided in a second size and shape). For example, the pores adjacent to the first end 302 may be imparted with a larger cross-sectional area than that of the pores adjacent to the second end 304.

Turning to FIG. 4A-4C, the pleated filter 204 may be provided in the form of a body 400 including a first end 402, a second end 404, a closed end cap 406, an open end cap 408, a first aperture 409 positioned in and extending through the open end cap 408, and the internal cavity 207 provided within the body 400. In multiple instances, the body 400 of the pleated filter 204 may include one or more pleats 412 designed for filtering particulates or contaminants from a fluid. In some instances, the first end 402 may be located at a bottom side of the pleated filter 204 and the second end 404 may be located at a top side of the pleated filter 204. As used here, “top side” and “bottom side” align with those discussed above in reference to the perforated enclosure 202, such that the top side of the pleated filter 204 may align with the top side of the perforated enclosure 202 when the multi-stage particulate filter 200 is assembled. It is to be appreciated, however, that the pleated filter 204 may be alternatively arranged with respect to the perforated enclosure 202.

In multiple instances, the first end 402 of the pleated filter 204 may be coupled to the closed end cap 406 and the second end 404 may be coupled to the open end cap 408. The end caps 406, 408 may be coupled to the pleated filter 204 by mechanical or adhesive means. In instances where the end caps 406, 408 are coupled to the pleated filter 204 by mechanical fasteners, the end caps 406, 408 may be designed to be detached from and recoupled to the body 400. In other instances, the end caps 406, 408 may be integrally formed with the pleated filter 204, such that the end caps 406, 408 may not be detached from the body 400. In yet other instances, the pleated filter 204 may be provided without the end caps 406, 408.

The first aperture 409 may be positioned at or near the center of the open end cap 408 and may extend through the end cap 408. In some instances, the first aperture 409 may be configured in any shape. For example, the first aperture 409 may be substantially cylindrical or circular.

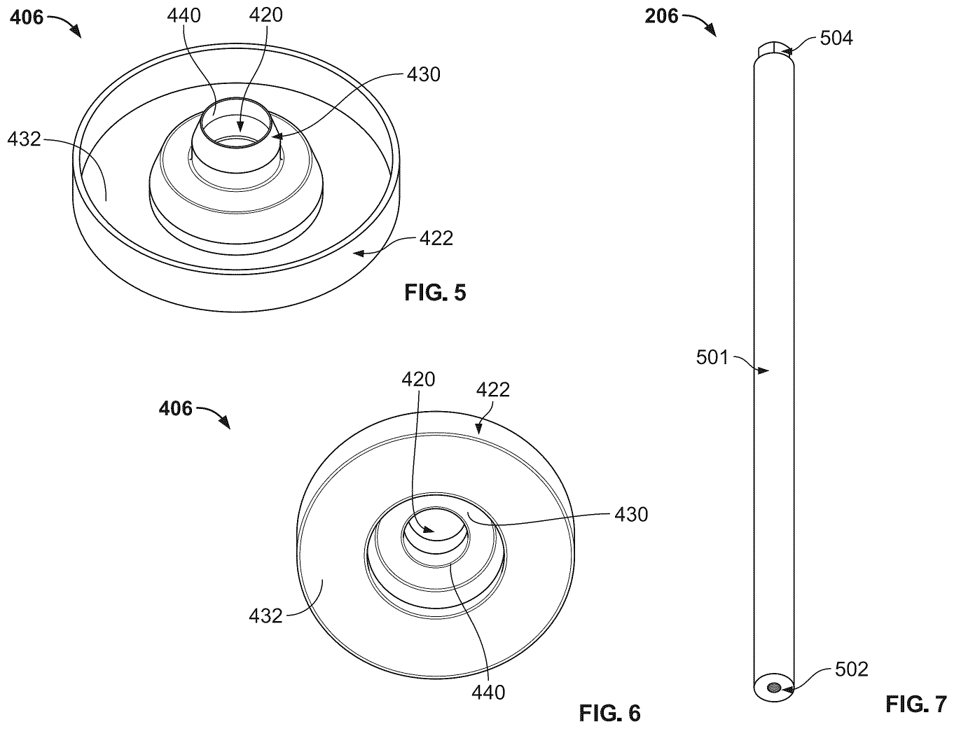

In various instances, the closed end cap 406 may not include an aperture and thus may be configured to close the pleated filter 204 at the first end 402. In other instances, including as shown in FIGS. 5 and 6, the closed end cap 406 may include an aperture extending therethrough.

The pleated filter 204 may be positioned inside the body 301 of the perforated enclosure 202 of FIGS. 3A and 3B. In some instances, the closed end cap 306 of the perforated enclosure 202 and the closed end cap 406 of the pleated filter 204 may be coupled to each other. Similarly, the open end cap 308 of the perforated enclosure 202 may enclose the open end cap 408 of the pleated filter 204. In various instances, the body 400 of the pleated filter 204 may be coupled to the closed end cap 406 and the open end cap 408. It is to be appreciated that the perforated enclosure 202 and the pleated filter 204 may be coupled together in manners other than those described herein.

Referring now to FIGS. 5 and 6 together, the closed end cap 406 of the pleated filter 204 may include a second aperture 420 extending through an end cap body 422 of the closed end cap 406, a protrusion 430 extending away from a base 432 of the end cap body 422. In addition, the second aperture 420 may be positioned in and extend through the protrusion 430. A contact surface 440 may form an interior surface of the protrusion 430 and may thus define the shape and size of the second aperture 420.

In some instances, the protrusion 430, and the second aperture 420 extending therethrough, may be provided in the form of any shape. In some cases, the geometry or shape of the protrusion 430 may be designed such that the closed end cap 406 may couple with a particular multi-stage particulate filter and/or a particular pressure vessel. In certain instances, the protrusion 430, and the second aperture 420 extending therethrough, may be sized and shaped to receive the magnetic rod 206. In some instances, the protrusion 430 may be provided as a substantially cylindrical, tapered funnel. In other instances, the protrusion 430 may be provided as another polygonal prism, including, but not limited to, rectangular, hexagonal, octagonal, and so on.

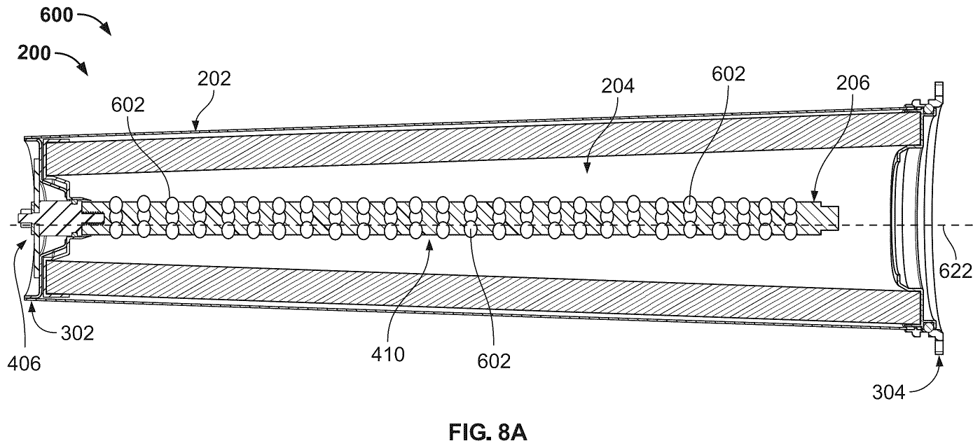

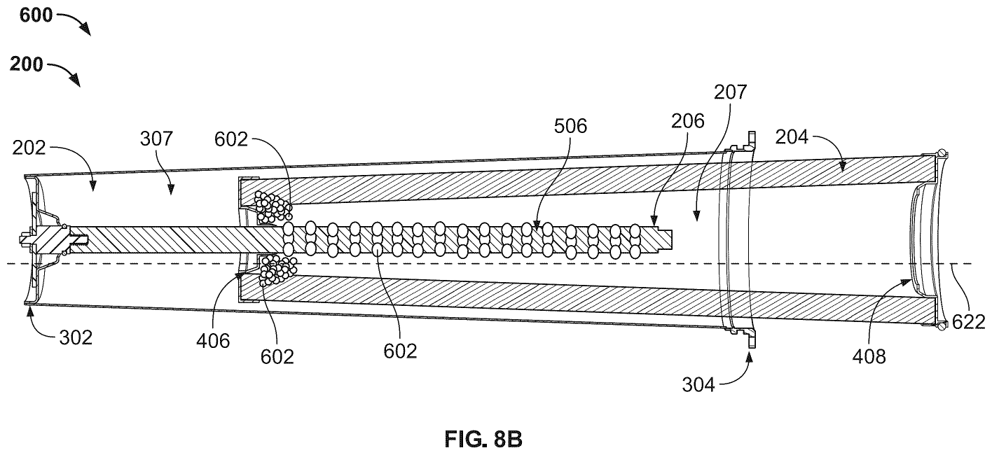

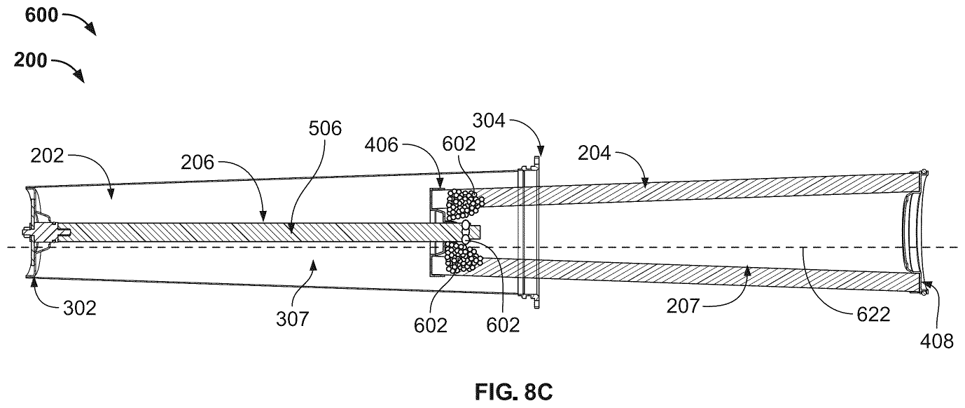

In some instances, the contact surface 440 of the closed end cap 406 may be configured to connect to, couple to, and/or abut the magnetic rod 206 when the pleated filter 204 is inserted in the multi-stage particulate filter 200. In various instances, the contact surface 440 of the closed end cap 406 may surround the second aperture 420 and may define the size and shape of the second aperture 420. The contact surface 440 may be designed to remove contaminants (e.g., ferromagnetic particles) from the magnetic rod 206 during a cleaning procedure (e.g., using a cleaning mechanism 600 as described with reference to FIGS. 8A-8C).

Turning to FIG. 7, the magnetic rod 206 of the multi-stage particulate filter 200 is provided in the form of a body 501 including a first rod end 502 and a second rod end 504. Generally, the magnetic rod 206 may be provided in the form of an elongated, thin cylinder, although the magnetic rod 206 may also be provided in other shapes and forms. For example, the magnetic rod 206 may be provided as a polygonal prism and/or may be provided in the form of multiple magnets coupled together to form an overall polygonal shape. In some instances, the first rod end 502 may be located at a bottom side of the magnetic rod 206 and the second rod end 504 may be located at a top side of the magnetic rod 206. As used here, “top side” and “bottom side” are used for convenience and to describe how the magnetic rod 206 may be oriented within the pressure vessel 100 relative to the other components of the pressure vessel 100 (e.g., the pleated filter 204, the closed end cap 406). It is to be understood that the magnetic rod 206 may be arranged in other manners with respect to the components of the pressure vessel 100 and the multi-stage particulate filter 200.

In additional instances, the first rod end 502 of the magnetic rod 206 may be received or accommodated in the second aperture 420 of the closed end cap 406 of the pleated filter 204 (see FIGS. 5 and 6), which in turn may also allow for the magnetic rod 206 to be coupled or fixed to the closed end cap 306 of the perforated enclosure 202 (see FIGS. 3A and 3B). In some instances, the magnetic rod 206 may be coupled to the closed end cap 306 of the perforated enclosure 202 by any fastening mechanism (e.g., the fastener 208 of FIGS. 2B and 2C). For example, the fastening mechanism may be mechanical, adhesive, welding, or any combination thereof. In some instances, the fastening mechanism may include threads, screws, nuts, or bolts. In various instances, the body 506 of the magnetic rod 206 may be housed within, surrounded by, or accommodated within the second aperture 420.

Referring to FIGS. 8A-8C, a cleaning mechanism 600 of the multi-stage particulate filter 200 is provided. The cleaning mechanism 600 may be designed to remove or dislodge ferromagnetic contaminants and/or particulates that have been collected by the magnetic rod 206, as described above. The cleaning mechanism 600 may be provided in the form of the closed end cap 406 of the pleated filter 204. To use the cleaning mechanism 600, the multi-stage particulate filter 200 may be moved from a first configuration (FIG. 8A) to a second configuration (FIG. 8B) and then a third configuration (FIG. 8C). As the multi-stage particulate filter 200 is moved from the first configuration to the third configuration, the pleated filter 204 (along with the closed end cap 406) may move along, or relative to, a longitudinal axis 622. As the pleated filter 204 moves along the longitudinal axis 622 and away from the first end 302, the pleated filter 204 may be removed from the perforated enclosure 202. In addition, as the pleated filter 204 is removed from the perforated enclosure 202, the magnetic rod 206 may be cleaned (e.g., ferromagnetic particles may be removed from the surface of the magnetic rod 206) as further described herein. It is to be understood that, in FIGS. 8A-8C, the pleats 412 of the pleated filter 204 are not illustrated for the sake of clarity.

FIG. 8A illustrates the first configuration of the multi-stage particulate filter 200. The first configuration may be the operating configuration of the multi-stage particulate filter 200. For example, the first configuration may be the configuration of the multi-stage particulate filter 200 within the pressure vessel 100 when the pressure vessel 100 may be filtering or processing a fluid. In some instances, the magnetic rod 206 may be partially, substantially, or completely coated with ferromagnetic particles 602 after the multi-stage particulate filter 200 processes one or more fluids including ferromagnetic particles. In some instances, when the multi-stage particulate filter 200 is in the first configuration, the pleated filter 204 and the closed end cap 406 are completely or substantially positioned inside the perforated enclosure 202. Furthermore, the magnetic rod 206 may be substantially or fully enclosed by or positioned within the pleated filter 204.

FIG. 8B illustrates the second configuration of the multi-stage particulate filter 200 in which the pleated filter 204 and the closed end cap 406 have been moved along the longitudinal axis 622 and away from the first end 302 of the perforated enclosure 202. Thus, in the second configuration, the pleated filter 204 may be at least partially removed from the interior 307 perforated enclosure 202 and the magnetic rod 206 may be only partially enclosed by or positioned within the internal cavity 207 of the pleated filter 204. As the pleated filter 204 is removed from the multi-stage particulate filter 200, the contact surface 440 (see FIGS. 5 and 6) of the closed end cap 406 may contact or scrape the body 506 of the magnetic rod 206, thereby removing the ferromagnetic particles 602 from the surfaces of the magnetic rod 206. As the pleated filter 204 moves along the longitudinal axis 622 and away from the first end 302 of the perforated enclosure 202, the ferromagnetic particles may gather on or near the contact surface 440 such that as the pleated filter 204 is removed from the perforated enclosure 202, the ferromagnetic particles do not fall into the body 400 of the pleated filter 204. In addition, the contact surface 440 may be designed to help prevent ferromagnetic particles from falling into the perforated enclosure 202 as the magnetic rod 206 is cleaned. For example, the contact surface 440 may be sized and shaped such that a diameter of the magnetic rod 206 and a diameter of the second aperture 420 are substantially equal. As an additional example, any gap provided between the magnetic rod 206 and the contact surface may be less than the average size of the ferromagnetic particles that accumulate on the magnetic rod 206. As another example, the contact surface 440 may be sized and shaped such that the contact surface 440 abuts the magnetic rod 206 while the pleated filter 204 is removed from the perforated enclosure 202.

FIG. 8C illustrates the third configuration in which the pleated filter 204 and the closed end cap 406 are substantially removed from the perforated enclosure 202. In some instances of the third configuration, the pleated filter 204 is substantially or completely removed from the interior 307 of the perforated enclosure 202. The removal of the pleated filter 204 from the perforated enclosure 202 may be accomplished by moving the pleated filter 204 along the longitudinal axis 622 and away from the first end 302 of the perforated enclosure 202. Further, since substantially all or all of the body 506 of the magnetic rod 206 has passed through the closed end cap 406 of the pleated filter 204, all or substantially all of the ferromagnetic particles 602 may be removed from the surface of the magnetic rod 206. After the pleated filter 204 is completely or substantially completely removed from the perforated enclosure 202, all or substantially all of the ferromagnetic particles 602 may be retained in the internal cavity 207 of the pleated filter 204, thereby completing the cleaning of the magnetic rod 206. For example, all, substantially all, or most of the ferromagnetic particles removed from the magnetic rod 206 during the cleaning process may accumulate near the protrusion 430 and/or the base 432 of the closed end cap 406 (the protrusion 430 and the base 432 best illustrated in FIGS. 5 and 6). Further, the magnetic rod 206 may remain inside the perforated enclosure 202 during the cleaning process and the removal of the pleated filter 204 from the perforated enclosure 202.

After the cleaning process is complete, the removed components (e.g., the pleated filter 204) may be replaced such that the functionality of the multi-stage particulate filter 200 may be restored. For example, a new pleated filter 204 may be inserted into the perforated enclosure 202 or the pleated filter 204 may be cleaned and then reinserted into the perforated enclosure 202. In instances where the pleated filter 204 is cleaned and reinserted into the perforated enclosure 202, the ferromagnetic particles gathered on the contact surface 440 may be removed by suitable mechanisms before the pleated filter 204 is reinserted into the perforated enclosure 202.

It is to be appreciated that actuating the cleaning mechanism 600, and the steps associated with using the cleaning mechanism 600, may be performed more than once to help ensure that substantially all or all the ferromagnetic particles 602 are removed from the magnetic rod 206. In some cases, the substantially all or all of the ferromagnetic particles 602 may be removed from the magnetic rod 206 upon a single actuation of the cleaning mechanism 600.

Advantageously, since the ferromagnetic particles 602 are attracted to and deposited on the magnetic rod 206 before the fluid passes through the pleated filter 204, the lifetime of the pleated filter 204 and/or the multi-stage particulate filter 200 may be increased. This increased lifetime is achieved because the ferromagnetic particles 602 are removed from the fluid before the fluid passes through the pleated filter 204, thereby helping to prevent the ferromagnetic particles from collecting in, collecting on, or clogging the pleated filter 204. Thus, the present disclosure provides an “early prevention solution” for preventing clogging of the pleated filter 204 by preventing the ferromagnetic particles 602 from being provided to the body 400 of the pleated filter 204.

In some instances, the arrangement of the components of the multi-stage particulate filter 200 may allow for the multi-stage particulate filter 200 to be used in the pressure vessel 100 and/or any other vessel, as desired.

As described with reference to FIGS. 1-8C, in some instances, the fluid may enter the multi-stage particulate filter 200 via the fluid inlet 108 of the pressure vessel 100. In various instances, the fluid may pass through the fluid inlet 108 and the tube sheet 112 to enter the multi-stage particulate filter 200. In multiple instances, the fluid may comprise ferromagnetic particles in addition to other solid particles that are dispersed in the fluid.

In some cases, when the fluid first enters the pleated filter 204 from the tube sheet 112 of the pressure vessel 100, the magnetic rod 206 may attract ferromagnetic particles 602 from the fluid, thereby removing some, substantially all, or all of the ferromagnetic particles from the fluid before the fluid passes through the body 400 of the pleated filter 204. In some instances, other particles (such as NaCl, SiO₂, CaCO₃, CaSO₄, MgO, etc.) may also be attracted and removed via the magnetic rod 206 due to cross-contamination or association of the other particles and the ferromagnetic particles. The fluid may then pass through the body 400 of the pleated filter, where the pleated filter may remove non-ferromagnetic particles and/or contaminants from the fluid, as well as any remaining ferromagnetic particles and/or contaminants in the fluid.

In some instances, a process of using the multi-stage particulate filter 200 includes a first filtration step, a second filtration step, and a cleaning step. The first filtration step may include providing a fluid to the multi-stage particulate filter 200 which includes a pleated filter 204 and a magnetic rod 206. Further, during the first filtration step, the fluid may be provided to the pleated filter 204 and the magnetic rod 206 may partially, substantially, or completely remove ferromagnetic particles from the fluid to create a prefiltered fluid. Then, in the second filtration step, the prefiltered fluid may pass through the pleated filter 204, thereby creating a treated fluid. The treated fluid may then leave the multi-stage particulate filter 200 by exiting through the body 301 of the perforated enclosure 202.

In some instances of the above-described process, the fluid provided to the multi-stage particulate filter 200 (i.e., an untreated fluid) may be imparted with a first contaminant concentration, the prefiltered fluid may be imparted with a second contaminant concentration, and the filtered fluid may be imparted with a third contaminant concentration. The contaminant concentration may include the concentration of ferromagnetic particulates and/or contaminants in the fluid or the concentration of both ferromagnetic and non-ferromagnetic particulates and/or contaminants in the fluid. In some such instances, the first contaminant concentration may be greater than both the second and third concentrations of contaminants. In addition, in some cases, the second contaminant concentration may be greater than the third contaminant concentration. In other cases, the second contaminant concentration may be substantially equal to the third contaminant concentration (e.g., if the magnetic rod 206 captures all of the contaminants in the untreated fluid). In yet other cases, the first contaminant concentration may be substantially equal to the second contaminant concentration (e.g., if there are no or substantially no ferromagnetic particles in the untreated fluid).

The cleaning step may be performed at predetermined time intervals, when performance of the multi-stage particulate filter 200 begins to drop, and/or as desired. The cleaning step may include removing magnetic particles (e.g., ferromagnetic particles) from the multi-stage particulate filter 200, i.e., the magnetic rod 206. In some instances, the removal of the ferromagnetic particles 602 from the magnetic rod 206 may be accomplished as described with reference to FIGS. 8A-8C. Thus, the cleaning step may include pulling the pleated filter 204 away from the first end 302 of the perforated enclosure 202 until the pleated filter 204 is substantially or completely removed from the perforated enclosure 202. As the pleated filter 204 is removed from the perforated enclosure 202, the ferromagnetic particles 602 may be removed from the surface of the magnetic rod 206 and accumulate within the pleated filter 204 and/or on the closed end cap 406 of the pleated filter 204. For example, the ferromagnetic particles may be removed from the magnetic rod 206 via physical contact between the closed end cap 406 (e.g., the contact surface 440 of the closed end cap 406) and the magnetic rod 206 as the magnetic rod 206 moves through the second aperture 420. Then, the ferromagnetic particles 602 can be disposed of along with the pleated filter 204 (e.g., in instances when the pleated filter 204 will be replaced with a new pleated filter) or washed out of the pleated filter 204 (e.g., in instances in which the pleated filter will be reused). While removing the pleated filter 204 and the closed end cap 306 from the perforated enclosure 202, the ferromagnetic particles 602 on the magnetic rod 206 may be substantially removed via the contact surface 440 positioned within the first aperture 409 of the closed end cap 406. In some instances, when removing the pleated filter 204 from the multi-stage particulate filter 200, the contact surface 440 contacts the body 506 of the magnetic rod 206, thereby partially, substantially, or completely removing ferromagnetic particles 602 from the body 501 of the magnetic rod 206.

In some instances, a technician or a user may utilize a handle (not shown) provided on the pleated filter 204 to help pull the pleated filter 204 out of the perforated enclosure 202. In various instances, the handle may be provided at the second end 404 of the pleated filter 204.

As depicted in FIGS. 8A-8C, in various instances of a method of cleaning a multi-stage particulate filter (e.g., the multi-stage particulate filter 200) described herein is disclosed. The method may be designed to increase the life and efficiency of a particulate filter by removing or preventing ferromagnetic particulates and/or contaminants from becoming trapped within a particulate filter (e.g., the pleated filter 204). The method may be utilized with any of the pressure vessels, particulate filters, or any variations thereof described herein.

The method may include providing a filtration apparatus comprising a pleated filter, a perforated housing, and a magnetic rod. The pleated filter and the magnetic rod may be disposed within the perforated housing, where the magnetic rod may be disposed within a cavity of the pleated filter defined by a body of the pleated filter. The magnetic rod may be imparted with ferromagnetic properties such that ferromagnetic particles may be attracted or affixed to the magnetic rod as the filtration apparatus filters fluid. The method may further include removing the pleated filter from the perforated housing, such that the pleated filter or a contact surface of the pleated filter scrapes or comes in physical contact with the magnetic rod. The method may still further include removing the ferromagnetic particles from the magnetic rod. In some cases, the method may include removing the pleated filter after a fluid has been processed or filtered by the filtration apparatus.

In some instances, the method may also include removing the pleated filter from the perforated housing and replacing the pleated filter with a clean pleated filter. In other instances, the method may also include cleaning the pleated filter, such that the captured ferromagnetic particles may be dislodged or removed from the pleated filter. In such instances, the method may further include replacing the pleated filter in the perforated housing.

In various instances, a method of filtering a fluid may be provided. The method may be designed to remove ferromagnetic contaminants from a fluid. The method may include providing a fluid, where the fluid may include a first concentration of ferromagnetic and non-ferromagnetic contaminants. The method may further include providing a filtration apparatus, where the filtration apparatus may include a pleated filter disposed within a perforated housing and a magnetic rod positioned within the pleated filter. The method may also include removing some, most, substantially all, or all of the ferromagnetic particles from the fluid being processed by the filtration apparatus, such that the fluid may be imparted with a second concentration of contaminants. The method may further include filtering fluid the with the pleated filter, such that non-ferromagnetic contaminant particles may be removed from the fluid, along with any remaining ferromagnetic contaminants, thus imparting the fluid with a third concentration of contaminants. In some cases, filtering the fluid with the pleated filter is performed after ferromagnetic contaminants have been removed from the fluid by the magnetic rod.

In some instances of the above-described method, the fluid provided to the filtration apparatus (i.e., an untreated fluid) may be imparted with the first concentration of contaminants, a prefiltered fluid (i.e., a fluid from which the magnetic rod has removed ferromagnetic contaminants) may be imparted with the second concentration of contaminants, and the filtered fluid (i.e., a fluid which has been filtered by both the magnetic rod and the pleated filter) may be imparted with the third concentration of contaminants. The concentration of contaminants may include the concentration of ferromagnetic particulates and/or contaminants in the fluid or the concentration of both ferromagnetic and non-ferromagnetic particulates and/or contaminants in the fluid. In some such instances, the first concentration of contaminants may be greater than both the second and third concentrations of contaminants. In addition, in some cases, the second concentration of contaminants may be greater than the third concentration of contaminants. In other cases, the second concentration of contaminants may be substantially equal to the third concentration of contaminants. In yet other cases, the first concentration of contaminants may be substantially equal to the first concentration of contaminants.

It is to be appreciated that any of the steps of the processes and methods described herein may be omitted or performed more than once. In addition, the steps of the processes and methods described herein may be performed in any order.

The present disclosure further provides an easy and do-it-yourself cleaning mechanism for removing the ferromagnetic particles 602 from the magnetic rod 206, which automatically cleans the magnetic rod 206 whenever the pleated filter 204 is removed from the perforated enclosure 202. In addition, the present disclosure also provides an easy way to collect the deposited particles, which may be used for further analysis in a lab for process optimization.

It will be appreciated by those skilled in the art that while the disclosure has been described above in connection with particular instances and examples, the disclosure is not necessarily so limited, and that numerous other instances, examples, uses, modifications and departures from the instances, examples and uses are intended to be encompassed by the claims attached hereto. The entire disclosure of each patent and publication cited herein is incorporated by reference, as if each such patent or publication were individually incorporated by reference herein. Various features and advantages of the disclosure are set forth in the following claims.

1. An apparatus comprising:
a housing; and
a multi-stage particulate filter positioned within the housing, the multi-stage particulate filter designed to create a filtered fluid from an untreated fluid, the multi-stage particulate filter comprising:
an enclosure having a first end and a second end;
a magnetic rod configured to remove magnetic particles from the untreated fluid passing through the multi-stage particulate filter; and
a pleated filter designed to selectively couple to the enclosure, the pleated filter including a closed end cap couplable to the first end of the enclosure.

2. The apparatus of claim 1, wherein the housing is provided in the form of a pressure vessel and comprises a fluid inlet in fluid communication with a source of the untreated fluid and a fluid outlet that provides the filtered fluid from the pressure vessel.

3. The apparatus of claim 2, wherein the housing further includes a tube sheet designed to receive the fluid from the fluid inlet and pass the fluid to the multi-stage particulate filter.

4. The apparatus of claim 1, wherein:
the magnetic rod attracts the magnetic particles from the untreated fluid to create a prefiltered fluid during a first filtration stage, and
the pleated filter filters the prefiltered fluid to create the filtered fluid during a second filtration stage.

5. The apparatus of claim 4, wherein:
the untreated fluid is imparted with a first contaminant concentration,
the prefiltered fluid is imparted with a second contaminant concentration,
the filtered fluid is imparted with a third contaminant concentration, and
the first contaminant concentration is greater than both the second contaminant concentration and the third contaminant concentration.

6. The apparatus of claim 1, wherein:
the closed end cap further includes a body with an opening extending through the body, the opening configured to receive the magnetic rod, and
the opening further includes a contacting surface designed to remove the magnetic particles deposited on the magnetic rod when the magnetic rod is moved through the opening.

7. The apparatus of claim 1, wherein:
the magnetic rod comprises a first rod end and a second rod end, the first rod end comprising a fastening mechanism, and
the first rod end of the magnetic rod is coupled to the first end of the enclosure by the fastening mechanism and the closed end cap of the pleated filter is sized and shaped to receive the magnetic rod.

8. The apparatus of claim 1, wherein the pleated filter further includes a hollow cavity that is in fluid communication with the second end of the enclosure.

9. The apparatus of claim 1, wherein:
the pleated filter is positioned within the enclosure when the pleated filter is coupled to the enclosure,
an aperture of the closed end cap is designed to receive the magnetic rod;
removal of the pleated filter from the enclosure removes the magnetic particles deposited on the magnetic rod, thereby cleaning the magnetic rod,
the magnetic rod remains coupled to the enclosure when the pleated filter is removed from the enclosure.

10. A filter comprising:
a perforated enclosure including a first end and a second end;
a pleated filter comprising a filter body and a closed end cap including an opening, the filter body defining a central cavity, wherein the closed end cap is couplable to the first end of the perforated enclosure; and
a magnetic rod positioned within the perforated enclosure, wherein the magnetic rod is couplable to the opening of the closed end cap and abuts the opening when coupled thereto, wherein the magnetic rod attracts particles from a fluid passing through the central cavity of the pleated filter,
wherein the pleated filter is selectively couplable to the perforated enclosure such that the pleated filter is selectively removable from the perforated enclosure.

11. The filter of claim 10, wherein the opening of the closed end cap is disposed around the magnetic rod such that a surface of the closed end cap removes particles deposited on the magnetic rod when the pleated filter is removed from the perforated enclosure.

12. The filter of claim 10, wherein a surface of the closed end cap is configured to contact a body of the magnetic rod when the magnetic rod is coupled to the closed end cap, and the surface of the closed end cap is configured to maintain contact with the body of the magnetic rod as the pleated filter is removed from the perforated enclosure.

13. The filter of claim 10, wherein the pleated filter is configured to be removed from the perforated enclosure by pulling the pleated filter away from the first end of the perforated enclosure.

14. The filter of claim 10, wherein the magnetic rod is received within the central cavity and the closed end cap of the pleated filter when the pleated filter is coupled to the perforated enclosure.

15. The filter of claim 10, wherein the magnetic rod is coupled to the perforated enclosure such that the magnetic rod remains coupled to the perforated enclosure as the pleated filter is removed from the perforated enclosure.

16. The filter of claim 10, wherein the magnetic rod is coupled to the closed end cap of the perforated enclosure via at least one fastening mechanism.

17. The filter of claim 10, wherein the perforated enclosure is provided in the form of a mesh structure configured to allow the fluid to flow through the perforated enclosure.

18. A method of filtering a fluid, the method comprising;
providing an untreated fluid;
providing a filtration apparatus comprising:
an enclosure;
a magnetic rod coupled to the enclosure; and
a pleated filter that substantially surrounds the magnetic rod when the pleated filter is inserted into the filtration apparatus;
removing magnetic particles from the untreated fluid with the magnetic rod, thereby generating a prefiltered fluid; and
filtering the prefiltered fluid with the pleated filter, thereby generating a filtered fluid.

19. The method of claim 18 further including cleaning the magnetic rod via removal of the pleated filter from the filtration apparatus.

20. The method of claim 18 wherein:
the untreated fluid is imparted with a first contaminant concentration,
the prefiltered fluid is imparted with a second contaminant concentration that is substantially equal to or less than the first contaminant concentration, and
the filtered fluid is imparted with a third contaminant concentration that is substantially equal to or less than the second contaminant concentration.
